(19) United States
(12) Patent Application Publication
(10) Pub. No.: US 2023/0108242 A1
(43) Pub. Date: Apr. 6, 2023

(54) SYSTEMS AND METHODS FOR QUICK CONNECT STORAGE SPRINKLERS AND FITTINGS

(71) Applicant: Tyco Fire Products LP, Lansdale, PA (US)

(72) Inventor: Jeremy Cogswell, Johnston, RI (US)

(73) Assignee: Tyco Fire Products LP, Lansdale, PA (US)

(21) Appl. No.: 17/800,432

(22) PCT Filed: Mar. 8, 2021
(86) PCT No.: PCT/IB2021/051921

§ 371 Date: Aug. 17, 2022

Related U.S. Application Data
(60) Provisional application No. 63/002,440, filed on Mar. 31, 2020.

(51) Int. Cl. A62C 35/68; F16L 15/00

(52) U.S. Cl. CPC A62C 35/68; F16L 15/008

(57) ABSTRACT

A sprinkler system includes a sprinkler, a fitting, and a gasket. The sprinkler includes a body having an inlet end and an opening, at least one flange extending radially outward from the body and positioned between the inlet end and the opening, and a sprinkler engagement member positioned between the at least one flange and the inlet end. The fitting includes an inner wall defining a fitting engagement member that couples with the sprinkler engagement member, an inner wall edge extending radially outward from the inner wall, and an end wall extending from the inner wall edge to an outer edge. The gasket is received between the at least one flange, the end wall, and the inner wall edge to seal the sprinkler with the fitting.

### CROSS-REFERENCE TO RELATED APPLICATIONS

The present application claims the benefit of and priority to U.S. Provisional Application No. 63/002,440, filed Mar. 31, 2020, the disclosure of which is incorporated herein by reference in its entirety.

### BACKGROUND

Sprinkler systems can be provided in buildings to address fire conditions. Sprinkler systems can include fire protection sprinklers and fittings that connect with piping systems to receive fluid to address the fire conditions.

### SUMMARY

At least one aspect relates to a sprinkler system. The sprinkler system includes a sprinkler, a fitting, and a gasket. The sprinkler includes a body having an inlet end and an opening, at least one flange extending radially outward from the body and positioned between the inlet end and the opening, and a sprinkler engagement member positioned between the at least one flange and the inlet end. The fitting includes an inner wall defining a fitting engagement member that couples with the sprinkler engagement member, an inner wall edge extending radially outward from the inner wall, and an end wall extending from the inner wall edge to an outer edge. The gasket is received between the at least one flange, the end wall, and the inner wall edge to seal the sprinkler with the fitting.

At least one aspect relates to a gasket of a sprinkler system. The gasket includes a wall defining an inner surface and an outer surface. An insert portion of the wall has a lesser thickness than a remainder of the wall, the insert portion defined from the inner surface.

At least one aspect relates to a method of installing a sprinkler. The method includes inserting an inlet end of the sprinkler into a fitting, a gasket is coupled with the sprinkler, the fitting defines an inner wall and an end wall extending from the inner wall that receives at least one flange of the sprinkler. The method includes rotating the sprinkler to engage a sprinkler engagement member of the sprinkler with a fitting engagement member of the fitting, the fitting engagement member defined by the inner wall, to seal the sprinkler with the fitting using the gasket.

At least one aspect relates to a piping assembly. The piping assembly can include a first fitting, a second fitting, and a gasket. The first fitting can include a body having an inlet end and an opening, at least one flange extending radially outward from the body and positioned between the inlet end and the opening, and a first engagement member positioned between the at least one flange and the inlet end. The second fitting can include an inner wall defining a second engagement member that couples with the first engagement member, an inner wall edge extending radially outward from the inner wall, and an end wall extending from the inner wall edge to an outer edge. The gasket can be on the at least one flange, and sized to be positioned between the at least one flange, the inner wall edge, and the end wall.

At least one aspect relates to a sprinkler. The sprinkler can include a body, at least one flange, an engagement member, at least one frame arm, a deflector, a seal, a thermal activation element, and a gasket. The at least one flange can extend radially outward from the body and positioned between the inlet end and the opening. The engagement member can be positioned between the at least one flange and the inlet end. The at least one frame arm can extend from the body. The deflector can be attached to the at least one frame arm. The seal can be positioned in an opening of the body fluidly coupled with the inlet end. The thermal activation element can be in contact with the seal and change state responsive to a fire condition to allow the seal to be moved out of the opening by fluid flowing through the body. The gasket can be positioned on the at least one flange.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

FIG. 1 depicts an example of a sprinkler system.

FIGS. 2A and 2B depict an example of a sprinkler, fitting, and gasket of a sprinkler system.

FIG. 3 depicts an example of a detail view of a sprinkler, fitting, and gasket of a sprinkler system.

FIG. 4 depicts an example of a gasket of a sprinkler system.

FIG. 5 depicts an example of a gasket and a sprinkler.

FIG. 6 depicts an example of a gasket and a sprinkler.

FIG. 7 depicts an example of a gasket.

FIG. 8 depicts an example of a cross-section view of a fitting that can receive a gasket and a remote fitting.

FIG. 9 depicts an example of a cross-section view of a fitting that can be received by a remote fitting.

The accompanying drawings are not intended to be drawn to scale. Like reference numbers and designations in the various drawings indicate like elements. For purposes of clarity, not every component can be labeled in every drawing. In the drawings:

### DETAILED DESCRIPTION

The present disclosure generally relates to fire sprinkler systems. More particularly, the present disclosure relates to a fire sprinkler that can be installed with greater speed, such as by reducing or avoiding the need to use pipe tape to properly seal the sprinkler to piping, or otherwise enabling tool-free installation. Fire sprinkler systems include sprinklers that can inhibit or permit flow of fluid (water or other fire suppressant fluid). In the instance of a fire or detected conditions that may be indicative of a fire (e.g., increased heat, smoke, etc.), the sprinklers can permit the flow of fluid such that the fluid may contact a deflector and be dispersed so as to address the fire. The sprinklers may disperse water or fire protection fluid over a specific area, for example a storage commodity, a portion of a room or hallway, or a window or wall. In order to accomplish fire exposure protection for a given area (e.g., room, hallway, window, wall, etc.), fire sprinklers couple with a piping system that directs fire suppressant from a source to the fire sprinklers. The fire sprinklers can selectively couple with the piping during installation of the fire suppression system. For example, fire sprinklers include threading that can interface with threading on the piping system to fluidly seal the fire sprinklers to the piping system. It can be difficult to properly install fire sprinklers such that the fire sprinklers are properly sealed.

Sprinkler systems in accordance with the present disclosure can include a sprinkler (or other fitting, such as a pipe, tee joint, elbow joint, cross joint, or pipe outlet, including threaded or grooved outlets or couplings) that includes a flange to stop insertion of the sprinkler into a fitting (e.g., adapter coupled with a pipe or the pipe itself) that receives the sprinkler, and a gasket that can be positioned between the sprinkler and fitting that includes dimples to provide an interference fit and a relief cut to decrease insertion forces. The sprinkler can include at least one of a flange and a shoulder that abuts the fitting to prevent overtightening to prevent deformation of the gasket. The system can implement particular sizes or ratios of features such as thread pitch, gasket height, and flange height to facilitate installation of the sprinkler. Various such features can enable a more rapid installation of the sprinkler while enabling proper sealing and preventing over torqueing.

For example, the sprinkler system can include a sprinkler, a fitting, and a gasket. The sprinkler can include a body having an inlet end and an opening. The sprinkler can be an early suppression fast response (ESFR) sprinkler. The sprinkler can include at least one flange extending radially outward from the body and positioned between the inlet end and the opening. The at least one flange can be sized to receive the gasket between the at least one flange and the fitting, and to abut an outer edge of the fitting to prevent overtightening or overcompression of the gasket. The sprinkler can include a sprinkler engagement member, such as a straight thread, positioned between the at least one flange and the inlet end. The fitting can include an inner wall defining a fitting engagement member that couples with the sprinkler engagement member, an inner wall edge extending radially outward from the inner wall, and an end wall extending from the inner wall edge to the outer edge. The fitting can be made from a weldable material. The gasket can be received between the at least one flange, the end wall, and the inner wall edge to seal the sprinkler with the fitting. The gasket can be made from a material having a Shore hardness greater than or equal to 50 and less than or equal to 60 durometers.

The sprinkler can be installed with fabricated (e.g., welded) steel piping systems. For example, the fitting can be welded to the steel piping, as the gasket is provided with (e.g., installed on) the sprinkler, rather than the fitting, and thus not in position to be deformed by the welding operation.

The sprinkler and various other components of the system can be used for storage applications, including but not limited to use for ceiling-only systems, and for ceiling heights up to and over fifty five feet. For example, the system can be used for storage commodities such as Class I, II, III or IV, Group A, Group B, or Group C plastics, elastomers, or rubber commodities, or any combination thereof. The storage commodity can be in an arrangement such as a single-row rack arrangement, a double-row rack arrangement, a multi-row rack arrangement, a palletized arrangement, a solid-piled arrangement, a bin box arrangement, a shelf arrangement, a back-to-back shelf arrangement, an on floor arrangement, and a rack without solid shelves arrangement, or any combination thereof. The system can be used in accordance with various standards, such as standards set forth by the National Fire Protection Association (NFPA) or FM Global.

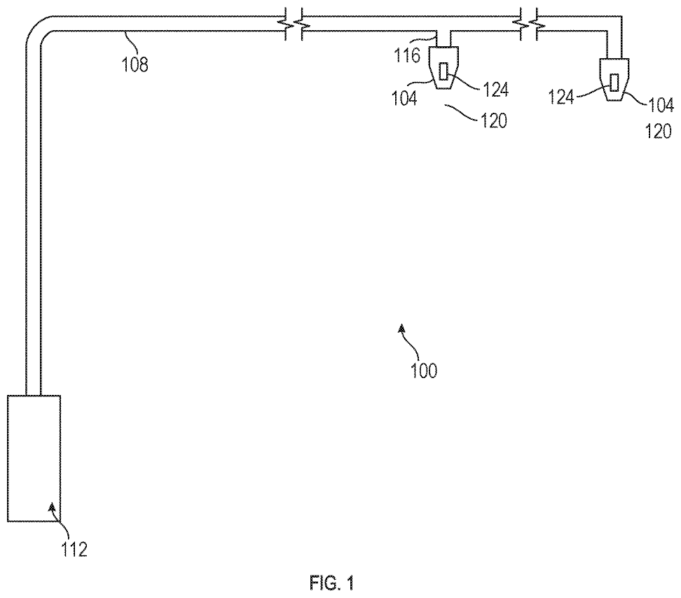

FIG. 1 depicts a fire suppression system 100. The fire suppression system 100 can be a chemical fire suppression system. The fire suppression system 100 can distribute a fire suppressant agent onto or nearby a fire, extinguishing the fire and preventing the fire from spreading. The fire suppression system 100 can be used alone or in combination with other types of fire suppression systems (e.g., a building sprinkler system, a handheld fire extinguisher). Multiple fire suppression systems 100 can be used in combination with one another to cover a larger area (e.g., each in different rooms of a building).

The fire suppression system 100 can be used in a variety of applications. The fire suppression system 100 can be used with a variety of fire suppressant agents, including but not limited to water (e.g., may use powders, liquids, foams, or other fluid or flowable materials). The fire suppression system 100 can be used for storage applications, including ceiling-only, in-rack, or a combination of ceiling and rack sprinklers, such as to be installed for storage commodities such as Class I, II, III or IV, Group A, Group B, or Group C plastics, elastomers, or rubber commodities, or any combination thereof. The storage commodity can be in an arrangement such as a single-row rack arrangement, a double-row rack arrangement, a multi-row rack arrangement, a palletized arrangement, a solid-piled arrangement, a bin box arrangement, a shelf arrangement, a back-to-back shelf arrangement, an on floor arrangement, and a rack without solid shelves arrangement, or any combination thereof.

The fire suppression system 100 can include or be coupled with a fluid supply 112. The fluid supply 112 can define an internal volume filled (e.g., partially filled, completely filled) with fire suppressant agent. The fluid supply 112 can provide fluid from a remote or local location to a building in which the fire suppression system 100 is located. The fluid supply may include, for example, a municipal water supply, pump, piping system, tank, cylinder, or any other source of water or fire suppression agent.

Piping 108 (e.g., one or more pipes, tubes, conduits) can be fluidly coupled with one or more sprinklers 104. The piping 108 can include vertical pipes 116. The vertical pipes 116 can extend perpendicular from the piping 108. The sprinklers 104 can receive water or other fire suppressant agent from the fluid supply 112 via the piping 108 and the vertical pipes 116. The sprinklers 104 can each define one or more outlets, through which the fire suppressant agent exits and contacts a deflector 120, such as to form a spray of water or other fire suppressant agent that covers a desired area. The sprays from the sprinklers 104 then suppress or extinguish fire within that area. The deflectors 120 of the sprinklers 104 can be shaped to control the spray pattern of the fire suppressant agent leaving the sprinklers 104. The sprinklers 104 can be used as concealed sprinklers, pendent sprinklers, upright sprinklers, water mist nozzles, or any other device for spraying fire suppressant agent.

The sprinklers 104 can include an activation element (e.g., thermal element) 124. The activation element 124 can change from a first state that prevents fluid flow out of the sprinkler 104 to a second state that permits fluid flow of the sprinkler 104 responsive to a fire condition. For example, the activation element 124 can include a glass bulb including a fluid that expands responsive to an increase in temperature (e.g., responsive to heat provided to the fluid from a fire), such as to cause the glass bulb to break responsive to the temperature meeting or exceeding a threshold temperature; the activation element 124 can include a fusible link that includes two or more pieces coupled using a solder than can melt responsive to the temperature meeting or exceeding a threshold temperature; the activation element 124 can include an electric actuator (e.g., an electrically triggered pyrotechnic actuator or electrically actuated bulb or link). The activation element 124 can have a response time index (RTI) less than or equal to 80 (m/s)^{1/2}, or less than or equal to 50 (m/s)^{1/2}.

The sprinklers 104 can be early suppression, fast response (ESFR) sprinklers. The sprinklers 104 can have K-factors greater than or equal to 14.0 GPM/PSI² and less than or equal to 36.0 GPM/PSI². The sprinklers 104 can be arranged (e.g., in a grid or tree arrangement over a storage commodity) to have sprinkler to sprinkler spacings greater than or equal to eight feet by eight feet and less than or equal to twelve feet by twelve feet.

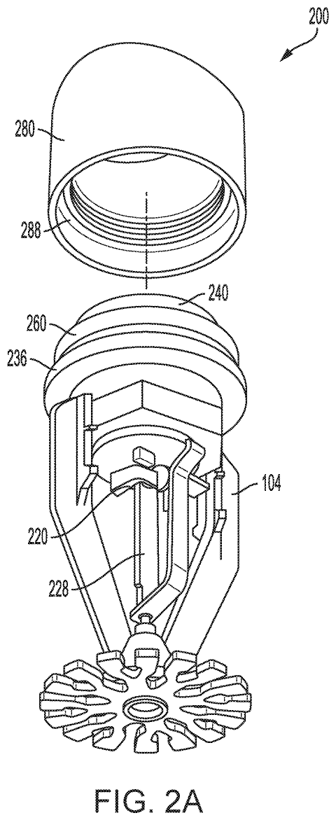

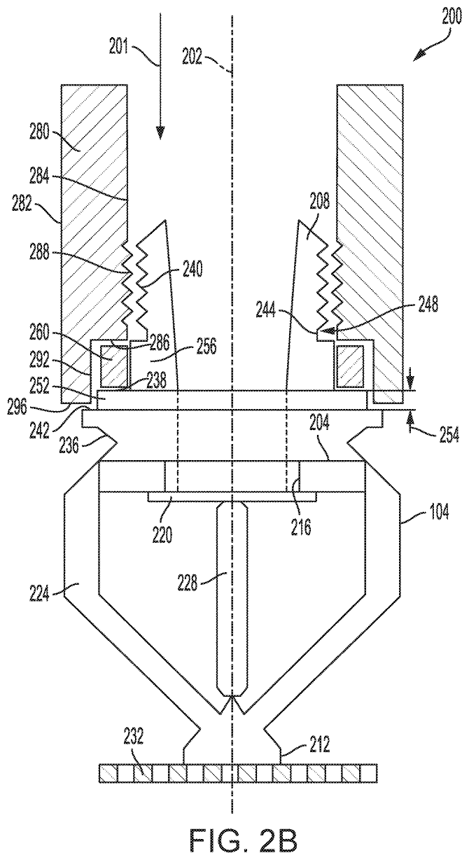

FIGS. 2A and 2B depicts a sprinkler system 200. The sprinkler system 200 can incorporate features and components of the fire suppression system 100 described with reference to FIG. 1. The sprinkler system 200 can be used for fire protection in various applications, including but not limited to storage applications. The sprinkler system 200 can be rapidly assembled to properly install and seal the sprinkler 104, and may not require pipe tape to complete the seal. The sprinkler 104 can be coupled with a fitting 280 to receive fluid flow in a direction 201 from the fitting 280. The fitting 280 can be an adapter (including but not limited to a welded or strap-on pipe outlet, tee fitting, or elbow fitting) to couple the sprinkler 104 with a pipe, or can form an outlet portion of the pipe (e.g., at least one of pipe 108 and pipe 116 described with reference to FIG. 1). At least one of the sprinkler 104 and the fitting 280 can be made from a metal (e.g., steel, brass, iron), or a polymeric material (e.g., plastic, CPVC). For example, the fitting 280 can be made of a weldable metal, such as steel, brass, or iron. The fitting 280 can be at least one machined and molded as a unitary structure. The sprinkler 104 can be an example of a body that can be provided with the gasket 260 to couple with the fitting 280, such as a body that includes the at least one flange 236 (e.g., flanges 236 and 252) and the gasket receiver 256, to be connected with the fitting 280 by hand (e.g., without using tools).

The fitting 280 can be welded to the piping 108. For example, the fitting 280 and piping 108 can be made of steel to be welded together. As described herein, the gasket 260 can be provided on the sprinkler 104, rather than in the fitting 280, so that the welding operation does not deform the gasket 260.

The sprinkler 104 includes a body 204 that can extend from an inlet end 208 to an outlet end 212. The body 204 can define an opening 216 through which fluid can flow from the fitting 280. The sprinkler 104 can include a seal 220, such as a button that can be positioned in the opening 216 to seal the opening 216.

The sprinkler 104 can include at least one frame arm 224 that extends from the body 204. The frame arms 224 can extend to the outlet end 212. The frame arms 224 can be radially outward relative to the opening 216 (e.g., to longitudinal axis 202 extending through the opening 216).

The sprinkler 104 can include an activation element 228 positioned between the seal 220 and the outlet end 212. The activation element 228 can incorporate features of the activation element 124 described with reference to FIG. 1. For example, the activation element 228 can include a glass bulb within which a fluid can expand to break the glass bulb responsive to temperature meeting or exceeding a threshold temperature, or a fusible link that can break responsive to the temperature meeting or exceeding the threshold temperature. The activation element 228 can apply a force on the seal 220 to secure the seal 220 in the opening 216. Responsive to the activation element 228 breaking, the seal 220 can move out of the opening 216 (e.g., by pressure of fluid in the body 204 applied against the seal 220), allowing fluid from the fitting to flow through the opening 216.

The sprinkler 104 can include a deflector 232. The deflector 232 can receive fluid from the fitting 280 through the opening 216 (e.g., responsive to the seal 220 moving out of the opening 216) and output the received fluid according to a target spray pattern. For example, the deflector 232 can include one or more tines shaped to cause the fluid to be outputted according to the target spray pattern. The deflector 232 can extend from the frame arms 224 (or a portion of the sprinkler 104 between the frame arms 224 and the deflector 232). The target spray pattern can correspond to an orientation of the deflector 232 (e.g., relative to longitudinal axis 202).

The sprinkler 104 can include at least one flange 236 between the inlet end 208 and the opening 216. The at least one flange 236 can define at least one support surface 238 that can contact the gasket 260 responsive to securing the sprinkler 104 with the fitting 280. The at least one flange 236 can form at least part of a neck portion of the sprinkler 104 that can be in contact with or received by the fitting 280.

The sprinkler 104 can include at least one engagement member 240 that can engage with the fitting 280. For example, as depicted in FIG. 2B, the at least one engagement member 240 can include threading that extends around the inlet end 208. The engagement member 240 can include straight thread, which can facilitate connection of the sprinkler 104 with the fitting 280.

The engagement member 240 can extend from the inlet end 208 to a gap portion 244 that defines a gap 248 between the engagement member 240 and the at least one flange 236. The gap portion 244 can be radially inward from outer edges of the engagement member 240 and from the at least one flange 236 (e.g., from the second flange 252) relative to a longitudinal axis 202.

The fitting 280 can include an inner wall 284 that defines at least one fitting engagement member 288. The fitting engagement member 288 can couple with (e.g., threadably engage with) the engagement member 240 of the sprinkler 104 to secure the fitting 280 with the sprinkler 104. The fitting engagement member 288 can be straight thread. At least a portion of the fitting 280 can define the fitting engagement member 288. Responsive to engaging the sprinkler 104 with the fitting 280 (e.g., threading the sprinkler 104 into the fitting 280), the at least one flange 236 can apply pressure on the gasket 260 to seal the sprinkler 104 with the fitting 280, such as to compress the gasket 260 between the sprinkler 104 and the fitting 280.

The fitting 280 can include an end wall 292 radially outward from the inner wall 284 (as depicted in FIG. 2B, an outer surface of 282 the fitting 280 opposite the inner wall 284 and end wall 292 can be continuous, having the same outer radius). The inner wall 284 can define an inner wall edge 286 (e.g., shelf) between the inner wall 284 and the end wall 292. The inner wall edge 286 can be opposite the at least one support surface 238 of the at least one flange 236 while the sprinkler 104 is received by the fitting 280. The end wall 292 and the at least one flange 236 of the sprinkler 104 can receive the gasket 260 so that the gasket 260 seals the sprinkler 104 and the fitting 280. For example, the gasket 260 can be received between the inner wall edge 286 and the end wall 292 of the fitting 280 and the support surface 238 and gasket receiver 256 of the sprinkler 104, such that engagement of the sprinkler 104 and the fitting 280 (e.g., using engagement members 240, 280) compresses the gasket 260 between the inner wall edge 286 and the support surface 238. As discussed below, an outer edge 296 of the end wall 292 can contact the at least one flange 236 of the sprinkler 104, enabling the at least one flange 236 to stop further movement of the sprinkler 104 into the fitting 280 (e.g., in a direction along longitudinal axis 202), such as to prevent overtightening of the sprinkler 104 with the fitting 280 and prevent overcompression of the gasket 260. The fitting 280 and sprinkler 104 can position the gasket 260 so that the gasket 260 is not in a flow path through the fitting 280 and the body 204.

The at least one flange 236 can include a first flange 236, a second flange 252, and a gasket receiver 256. The first flange 236 can extend further radially outward (e.g., has a greater outer diameter than) than the second flange 252 so that a support surface 242 of the first flange 236 contacts the outer edge 296 of the fitting 280. The second flange 252 can extend further radially outward than (e.g., has a greater outer diameter than) the gasket receiver 256, and can contact the gasket 260 (e.g., a sprinkler 104-facing portion of the gasket 260). The gasket receiver 256 can contact the gasket 260, allowing the gasket 260 to be retained on the gasket receiver 256 during installation as shown in FIG. 2A.

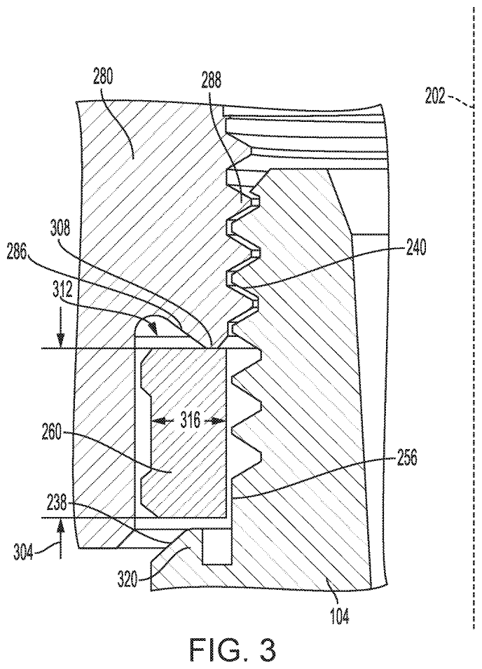

FIG. 3 depicts the sprinkler 104 coupled with the gasket 260 and the fitting 280. Various features of at least one of the sprinkler 104, gasket 260, and fitting 280 can be sized to facilitate rapid installation of the sprinkler 104 with proper sealing and alignment, such as to ensure that half or full turns (e.g., rotation within a threshold angle of three hundred sixty degrees, the threshold angle can be ten degrees) of the sprinkler 104 when threaded into the fitting 280 properly compress the gasket 260 and align the frame arms 224 (and, in turn, the deflector 232) at a target orientation.

For example, at least one of a height 254 of the second flange 252 (see FIG. 2B) and a pitch of the fitting engagement member 288 of the fitting can correspond to a height 304 of the gasket 260. The height 304 can be greater than 0.1 inches and less than 1 inch. The height 304 can be greater than 0.15 inches and less than 0.5 inches. The height 304 can be greater than 0.2 inches and less than 0.4 inches. The height 304 can be 0.237 inches.

The height 304 of the gasket 260 can define at least one of a minimum threshold and a maximum threshold, based on which features of at least one of the sprinkler 104 and the fitting 280 can be sized. The minimum threshold can correspond to a minimum engagement with the gasket 260 to enable sealing using the gasket 260 (e.g., to enable water tight sealing). The minimum threshold can be greater than ten percent and less than twenty percent of the height 304. The minimum threshold can be greater than twelve percent and less than eighteen percent of the height 304. The minimum threshold can be fifteen percent. For example, if the height 304 is 0.237 inches, then the minimum threshold can be fifteen percent of 0.237 inches, which is about 0.035 inches.

The thread pitch of the fitting engagement member 288 can correspond to the minimum threshold. For example, the thread pitch of the fitting engagement member 288 can be a lowest number of threads per inch such that a half turn (e.g., rotation within a threshold angle of one hundred eighty degrees around longitudinal axis 202, the threshold angle can be less than ten degrees) relative to the fitting engagement member 288 is greater than or equal to the minimum threshold.

For example, if the minimum threshold is 0.035 inches, the fitting engagement member 288 can have a pitch of fourteen threads per inch, which is about 0.07 inches per thread, such that a half turn of the sprinkler 104 will result in the fitting engagement member 288 engaging with 0.035 inches of the gasket 260, satisfying the minimum threshold. As another example, if the height 304 is 0.5 inches, fifteen percent of 0.5 inches is 0.075 inches, such that a pitch of the fitting engagement member 288 can be 6 threads per inch (0.16 inches per thread so that a half turn engages with 0.08 inches of the gasket 260).

The maximum threshold can correspond to a maximum engagement of the sprinkler 104 with the gasket 260 or the fitting 280, such as to ensure an appropriate amount of compression of the gasket 260 to seal the sprinkler 104 with the fitting 280 without overtightening or the components bottoming out with respect to one another (e.g., support surface 242 of the at least one flange 236 contacting outer edge 296 of the fitting 280). The maximum threshold is greater than the minimum threshold. The maximum threshold can be greater than or equal to twenty percent and less than or equal to sixty percent of the height 304. The maximum threshold can be greater than or equal to thirty percent and less than or equal to fifty percent of the height 304. The maximum threshold can be forty percent of the height 304. For example, if the height is 0.237 inches, then the maximum threshold can be forty percent of 0.237 inches, which is about 0.095 inches.

The height 254 of the second flange 252 can correspond to the maximum threshold. For example, the height 254 can be less than or equal to the maximum threshold. For example, if the maximum threshold is 0.095 inches, then the height 254 can be less than or equal to 0.095 inches. As another example, if the height 304 is 0.5 inches, forty percent of 0.5 inches is 0.2 inches, such that the height 254 can be less than or equal to 0.2 inches.

Because the gasket 260 is shielded from fluid flow by the gasket receiver 256 and the engagement member 240, the gasket 260 can be relatively soft. For example, the gasket 260 can be made from ethylene propylene diene monomer (EPDM) rubber. The gasket 260 can have a hardness greater than or equal to 50 durometers (e.g., Shore durometer) and less than or equal to 60 durometers. As such, the hardness of the gasket 260 can be low enough to facilitate hand-tightening of the sprinkler 104 with the fitting 280 (e.g., compared to harder materials, such as having hardnesses of 70-90 durometers, which may be used for gaskets to be installed relative to the sprinkler and fitting so that compression of the gasket can cause the gasket to extend radially inward into the fluid flow, restricting the fluid flow), such as by reducing the force required to tighten the sprinkler 104, and high enough to transmit a sensation of contact between the gasket 260 and the fitting 280 to a user installing the sprinkler 104 (e.g., as compared to further softer materials that may make it difficult to detect contact between the gasket 260 and the fitting 280 while tightening).

The gasket 260 can be made of various shapes, such as cross-sectional shapes. For example, the gasket 260 can have circular or rectangular cross-sections.

The inner wall edge 286 can be flat, such as depicted in FIG. 2B. The inner wall edge 286 can define an extension 308 that extends from the inner wall 284 adjacent to a void 312 between the inner wall 284 and the end wall 292. The extension 308 can apply force against the gasket 260 using less surface area, which can help prevent a leak path forming around the gasket 260 when sealing the sprinkler 104 and the fitting 280. The extension 308 can extend parallel to the longitudinal axis 202 (see FIG. 2B) and from a radially inward portion of the inner wall 284 relative to the void 312.

The support surface 238 of the sprinkler 104 can define an extension 320 that extends from the at least one flange 236 to apply force against the gasket 260 using less surface area. The extension 320 can extend from the at least one flange 236 in a direction towards the engagement member 240 (e.g., parallel to the longitudinal axis 202).

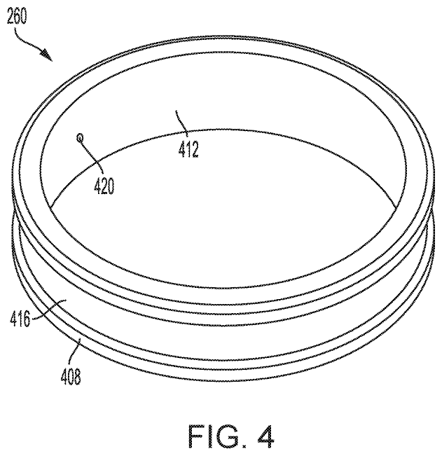

FIG. 4 depicts an example of the gasket 260. The gasket 260 can include a wall 404 defining an outer surface 408 and an inner surface 412. The outer surface 408 can define an insert portion 416 around a center of the wall 404 (e.g., a central region relative to the longitudinal axis 202 when the gasket 260 is received between the sprinkler 104 and fitting 280). The insert portion 416 can have a lesser thickness than a remainder of the wall 404 (see, e.g., thickness 316 defined by the insert portion 416 as depicted in FIG. 3). By providing the insert portion 416 with a lesser thickness, the gasket 260 can have a relief cut that can decrease insertion forces for coupling the sprinkler 104 with the fitting 280, which can facilitate toolless installation of the sprinkler 104.

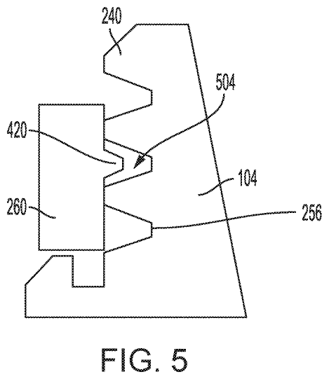

As depicted in FIG. 4 and FIGS. 5-7, the gasket 260 can include at least one extension 420 that extends radially inward from the inner surface 412. The extensions 420 can be bumps or dimples formed on the inner surface 412. The extensions 420 can enable an interference fit between the gasket 260 and the sprinkler 104, which can help prevent the gasket 260 from falling off the sprinkler 104 prior to installation in fitting 280 even as the orientation of the sprinkler 104 is modified (e.g., if the sprinkler 104 is turned upside down). The extensions 420 can be positioned symmetrically around the inner surface 412 (e.g., within a threshold angle of being equally angularly spaced one another; the threshold angle can be less than ten degrees, less than five degrees, less than one degree). As depicted in FIG. 5, the threads of the engagement member 240 may form part of the gasket receiver 256 (e.g., the engagement member 240 can be on the surface of the gasket receiver 256), and the extensions 420 can be received between the threads of the engagement member 240 (e.g., in voids 504) to enable the interference fit.

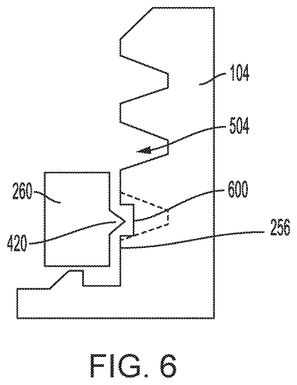

FIG. 6 depicts an example of the sprinkler 104 including a groove 600 formed on the gasket receiver 256 between the engagement member 240 and the extension 320 of the sprinkler 104. The groove 600 can receive the extensions 420 of the gasket 260 to enable the interference fit between the sprinkler 104 and the gasket 260. As depicted in FIG. 6, the groove can have a depth less than a depth of the voids 504 formed between the threads of the engagement member 240.

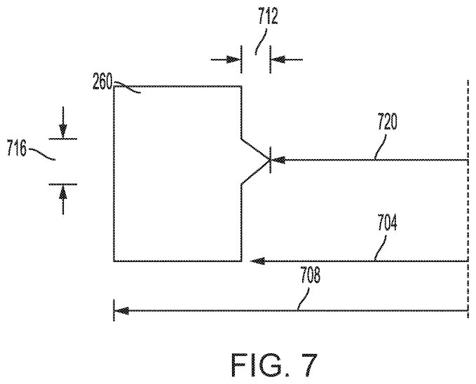

FIG. 7 depicts dimensions of the gasket 260, which can enable the gasket 260 to effectively seal the sprinkler 104 with the fitting 280. The gasket 260 can define an inner radius 704 and an outer radius 708 relative to a gasket axis 700 (the gasket axis 700 can align with the longitudinal axis 202 when the gasket 260 is coupled with the sprinkler 104).

The inner radius 704 can be greater than or equal to 0.75 inches and less than or equal to 2.5 inches. The inner radius 704 can be greater than or equal to 1 inch and less than or equal to 2 inches. The inner radius 704 can be greater than or equal to 1.2 inches and less than or equal to 1.5 inches. The inner radius 704 can be 1.38 inches.

The outer radius 708 can be greater than or equal to 1 inch and less than or equal to 3 inches. The outer radius 708 can be greater than or equal to 1.2 inches and less than or equal to 2.2 inches. The outer radius 708 can be greater than or equal to 1.4 inches and less than or equal to 1.6 inches. The outer radius 708 can be 1.5 inches. A ratio of the inner radius 704 to the outer radius 708 can be greater than 1:1.05 and less than 1:1.5. The ratio can be 1:1.09.

The extension 420 of the gasket 260 can define a length 712 and a height 716, such as to enable the interference fit between the gasket 260 and the sprinkler 104. The length 712 can be greater than 0.01 inches and less than 0.1 inches. The length 712 can be greater than 0.02 inches and less than 0.05 inches. The length 712 can be 0.04 inches.

The height 716 can be greater than 0.02 inches and less than 0.12 inches. The height 716 can be greater than 0.03 inches and less than 0.09 inches. The height 716 can be greater than 0.04 inches and less than 0.08 inches. The height 716 can be 0.06 inches. A ratio of the length 712 to the height 716 can be greater than 1:1.1 and less than 1:2. The ratio can be 1:1.3.

The extension 420 can define an inner radius 720. The inner radius 720 can enable the extension 420 to be received by the engagement member 240 of the sprinkler 104. The inner radius 720 can be greater than 1 inch and less than two inches. The inner radius 720 can be greater than 1.2 inches and less than 1.5 inches. The inner radius 720 can be greater than 1.3 inches and less than 1.4 inches. The inner radius 720 can be 1.34 inches.

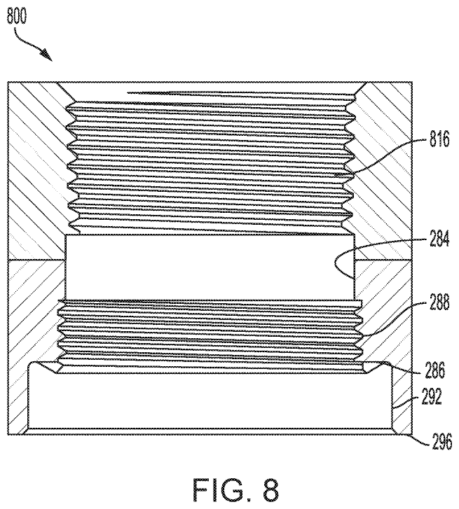

FIG. 8 depicts an example of a fitting 800. The fitting 800 can incorporate features of and be used to implement the fitting 280 described with reference to FIGS. 2A and 2B. The fitting 800 can be attached to the piping 108 by welding or engagement with an engagement member of the piping 108 and second engagement member 816. The fitting 800 can enable toolless installation of a remote fitting to the fitting 800, along with connection of the remote fitting with the piping 108.

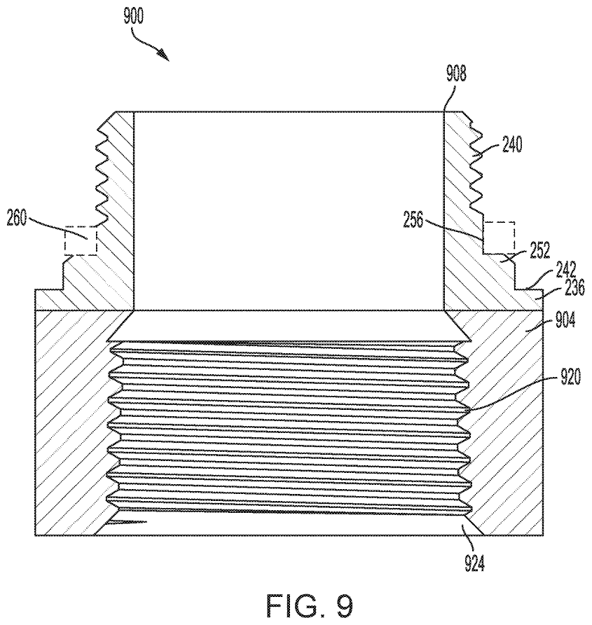

The fitting 800 can include the inner wall 284 defining the fitting engagement member 288. The fitting engagement member 288 can engage an engagement member of a remote fitting (e.g., the at least one engagement member 240 of the sprinkler 104 or of the fitting 900 described with reference to FIG. 9). The fitting engagement member 288 can have a straight thread, such as to facilitate toolless coupling of the remote fitting with the fitting 800.

The fitting 800 can include the end wall 292. The end wall 292 can have a greater inner diameter than the fitting engagement member 288. The end wall 292 can receive the remote fitting, as well as a gasket (e.g., gasket 260 described with reference to FIGS. 2A, 2B, and 3-7) positioned on an outer wall of the remote fitting to seal the fitting 800 and the remote fitting. For example, the gasket can be received between the end wall 292 and the remote fitting and outside of contact between the fitting engagement member 288 and an engagement member of the remote fitting, enabling the gasket to seal the connection between the fittings without being exposed to fluid flow between the fittings.

The fitting 800 can include a second engagement member 816. The second engagement member 816 can enable threaded engagement between the fitting 800 and components such as piping 108. The second engagement member 816 can include at least one of an interference thread or national pipe thread (NPT). The second engagement member 816 can be spaced from the fitting engagement member 288 along the inner wall 284.

FIG. 9 depicts an example of a fitting 900. The fitting 900 can be connected with the fitting 800. For example, a toolless installation can be performed in which the fitting 900 is moved into the fitting 800, and threaded to engage with the fitting engagement member 288, while a gasket (e.g., gasket 260 described with reference to FIGS. 2A, 2B, and 3-7) is positioned between the fitting 800 and the fitting 900. The fitting 900 can incorporate features of the sprinkler 104; for example, the sprinkler 104 can be an example of the fitting 900. The fitting 900 can be implemented as various types of fittings, including but not limited to sprinklers, tee joints, cross joints, elbow joints, pipe outlets, and pipe couplings. The fittings 800, 900 can be provided as a piping assembly.

The fitting 900 includes a body 904 having the at least one flange 236 extending from the body 904 to an inlet end 908. The body 904 can include or be coupled with various components, such as sprinklers, pipe joints, or pipe couplings. For example, as depicted in FIG. 9, the body 904 can define an inner engagement member 920 extending to an outlet end 924 to connect a first remote fitting (e.g., fittings 280, 800) with the inlet end 908 and a second remote fitting with the outlet end 924.

The fitting 900 includes the at least one engagement 240 between the at least one flange 236 and the inlet end 908. The inlet end 908 can be inserted into a remote fitting (e.g., fittings 280, 800) and connected with the remote fitting, such as by threaded engagement between the at least one engagement member 240 and a corresponding engagement member of the remote fitting.

The at least one flange 236 can incorporate features of the at least one flange 236 of the sprinkler 104. For example, the at least one flange 236 is depicted to include a first flange 236 and a second flange 252. The at least one flange 236 can receive a gasket (e.g., gasket 260 described with reference to FIGS. 2A, 2B, and 3) on the at least one flange 236, such as adjacent to gasket receiver 256 (which can position the gasket away from the engagement member 240, such as radially outward from the engagement member 240). The first flange 236 can be sized to abut a remote fitting into which the inlet end 908 is inserted, such as by extending further radially outward than the engagement member 916, to prevent overtightening and overcompression of the gasket 260 between the fitting 900 and the remote fitting.

As utilized herein, the terms “approximately,” “about,” “substantially”, and similar terms are intended to include any given ranges or numbers +/−10%. These terms include insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The construction and arrangement of the fitting assembly as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A sprinkler system, comprising:
a sprinkler comprising a body having an inlet end and an opening, at least one flange extending radially outward from the body and positioned between the inlet end and the opening, and a sprinkler engagement member positioned between the at least one flange and the inlet end;
a fitting comprising an inner wall defining a fitting engagement member that couples with the sprinkler engagement member, an inner wall edge extending radially outward from the inner wall, and an end wall extending from the inner wall edge to an outer edge; and
a gasket that is received between the at least one flange, the end wall, and the inner wall edge to seal the sprinkler with the fitting.

2. The sprinkler system of claim 1, comprising:
the sprinkler is an early suppression fast response (ESFR) sprinkler.

3. The sprinkler system of claim 1, comprising:
the fitting is made of a weldable metal.

4. The sprinkler system of claim 1, comprising:
the fitting is at least one of machined and molded as a unitary structure.

5. The sprinkler system of claim 1, comprising:
the at least one flange comprises a first flange that is positioned to contact the outer edge of the fitting, and a second flange that extends radially outward less than the first flange and is positioned to contact the gasket.

6. The sprinkler system of claim 1, comprising:
the gasket comprises an insert portion having a thickness less than a remaining portion of the gasket.

7. The sprinkler system of claim 1, comprising:
the at least one flange comprises a first flange that is positioned to contact the outer edge, a second flange that extends radially outward less than the first flange and is positioned to contact the gasket, and a gasket receiver that extends radially outward less than the second flange and receives the gasket; and
a height of the second flange corresponds to a height of the gasket.

8. The sprinkler system of claim 1, comprising:
the at least one flange comprises a first flange that contacts the outer edge of the fitting and a second flange that extends radially outward less than the first flange and is positioned to contact the gasket; and
a height of the second flange is less than or equal to a maximum threshold corresponding to forty percent of a height of the gasket.

9. The sprinkler system of claim 1, comprising:
the fitting engagement member comprises threading that defines a thread pitch, the thread pitch corresponds to a height of the gasket.

10. The sprinkler system of claim 1, comprising:
the fitting engagement member comprises threading that defines a thread pitch, the thread pitch corresponds to a minimum threshold corresponding to fifteen percent of a height of the gasket.

11. The sprinkler system of claim 1, comprising:
the sprinkler engagement member and the fitting engagement member each comprise straight thread.

12. The sprinkler system of claim 1, comprising:
the gasket is sized to be seal by rotation of the sprinkler between one hundred eighty degrees and three hundred sixty degrees of engagement between the sprinkler engagement member and the fitting engagement member.

13. The sprinkler system of claim 1, comprising:
the gasket comprises at least one extension that extends radially inward from an inner surface of the gasket to form an interference fit with the sprinkler.

14. The sprinkler system of claim 1, comprising:
an extension that extends from the end wall to contact the gasket, the extension defines a void radially outward from the extension and between the extension and the end wall.

15. The sprinkler system of claim 1, comprising:
an extension that extends from the at least one flange to contact the gasket.

16. The sprinkler system of claim 1, comprising:
the fitting is at least one of coupled with or integrally formed with a pipe that receives fluid to output through the sprinkler.

17. The sprinkler system of claim 1, comprising:
the gasket has a hardness greater than or equal to 50 and less than or equal to 60 durometers.

18. A piping assembly of a sprinkler system, comprising:
a first fitting comprising a body having an inlet end and an opening, at least one flange extending radially outward from the body and positioned between the inlet end and the opening, and a first engagement member positioned between the at least one flange and the inlet end;
a second fitting comprising an inner wall defining a second engagement member that couples with the first engagement member, an inner wall edge extending radially outward from the inner wall, and an end wall extending from the inner wall edge to an outer edge; and
a gasket on the at least one flange, the gasket sized to be positioned between the at least one flange, the inner wall edge, and the end wall.

19. The piping assembly of claim 18, comprising:
the first fitting is at least one of a pipe outlet, a tee joint, an elbow joint, a cross joint, and a sprinkler.

20. The piping assembly of claim 18, comprising:
the second fitting comprises a third engagement member on an opposite end of the second fitting from the second engagement member, the third engagement member comprising at least one of an interference thread and a national pipe thread (NPT).

21. A sprinkler, comprising:
a body having an inlet end and an opening;
at least one flange extending radially outward from the body and positioned between the inlet end and the opening;
an engagement member positioned between the at least one flange and the inlet end;
at least one frame arm extending from the body;
a deflector attached to the at least one frame arm;
a seal positioned in an opening of the body fluidly coupled with the inlet end;
a thermal activation element in contact with the seal, the thermal activation element changes state responsive to a fire condition to allow the seal to be moved out of the opening by fluid flowing through the body; and
a gasket positioned on the at least one flange.
